(19) United States
(12) Patent Application Publication
(10) Pub. No.: US 2018/0350344 A1
(43) Pub. Date: Dec. 6, 2018

(54) SYSTEM, DEVICE, AND METHOD FOR AN ELECTRONIC DIGITAL ASSISTANT HAVING A CONTEXT DRIVEN NATURAL LANGUAGE VOCABULARY

(71) Applicant: MOTOROLA SOLUTIONS, INC, CHICAGO, IL (US)

(72) Inventors: BENJAMIN ZASLOW, CHICAGO, IL (US); EVGENY MARYASKIN, ST. PETERSBURG (RU); CHARLES SPENGLER, HOFFMAN ESTATES, IL (US)

(21) Appl. No.: 15/607,791

(22) Filed: May 30, 2017

(51) Int. Cl. G10L 13/047; G06F 17/27; G10L 13/08

(52) U.S. Cl. CPC G10L 13/047; G10L 13/08; G06F 17/2785; G06F 17/2795

(57) ABSTRACT

An electronic digital assistant (EDA) detects a user's acoustical environment and substantively varys a content of a generated auditory output to the user as a function of the detected acoustical environment. The EDA receives an indication of an acoustic environment in which an auditory output will be provided to a user. The EDA then generates an auditory output having a substantive content that is varied as a function of the indicated acoustic environment. The EDA then provides the auditory output to an electronic output transducer associated with the user for reproduction to the user in the acoustic environment.

### BACKGROUND OF THE INVENTION

Tablets, laptops, phones (e.g., cellular or satellite), mobile (vehicular) or portable (personal) two-way radios, and other mobile computing devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such mobile computing devices further comprise, or provide access to, electronic digital assistants (or sometimes referenced as “virtual partners”) that can provide the user thereof with valuable information in an automated (e.g., without further user input) or semi-automated (e.g., with some further user input) fashion. The valuable information provided to the user can be based on explicit requests for such information posed by the user via an input (e.g., such as a parsed natural language input or an electronic touch interface manipulation associated with an explicit request) in which the electronic digital assistant may reactively provide such requested valuable information, or can be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, and providing many other types of information in a reactive or proactive manner.

In many cases, the electronic digital assistant may perform a task, whether in a reactive or proactive manner, that results in an auditory output being generated and provided to a user via his or her mobile computing device. However, a problem exists in that some environments in which the user may operate the mobile computing device are not as amenable to an electronic digital assistant provided auditory response as other environments. For example, continuous or periodic background noise may make it difficult for the user to hear and/or understand the auditory response, or may cause the user to misunderstand (e.g., incorrectly hear) the auditory response due to the noise.

Thus, there exists a need for an improved technical method, device, and system for an electronic digital assistant to detect a user's acoustical environment and to substantively vary a content of its auditory output to the user as a function of the detected acoustical environment.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a system for operating an electronic digital assistant, in accordance with some embodiments.

FIG. 2 is a device diagram showing a device structure of an electronic computing device for operating an electronic digital assistant, in accordance with some embodiments.

FIG. 3 illustrates a flowchart setting forth process steps for operating the electronic digital assistant of FIGS. 1 and/or 2, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method, device, and system for an electronic digital assistant to detect a user's acoustical environment and to substantively vary a content of its auditory output to the user as a function of the detected acoustical environment.

In one embodiment a process at an electronic digital assistant computing device for detecting a user's acoustical environment and substantively varying a content of a generated auditory output to the user as a function of the detected acoustical environment includes: receiving, at an electronic digital assistant computing device, an indication of an acoustic environment in which an auditory output will be provided by the electronic digital assistant computing device to a user; generating, at the electronic digital assistant computing device, an auditory output having a substantive content that is varied as a function of the indicated acoustic environment; and providing, by the electronic digital assistant computing device, the auditory output to an electronic output transducer associated with the user for reproduction to the user in the acoustic environment.

In a further embodiment a computing device implementing an electronic digital assistant for detecting a user's acoustical environment and substantively varying a content of an auditory output to the user as a function of the detected acoustical environment includes: a memory storing non-transitory computer-readable instructions; a transceiver; and one or more processors configured to, in response to executing the non-transitory computer-readable instructions, perform a first set of functions comprising: receive, via one of the transceiver and a sensor communicably coupled to the electronic digital assistant computing device, an indication of an acoustic environment in which an auditory output will be provided by the electronic digital assistant computing device to a user; generating an auditory output having a substantive content that is varied as a function of the indicated acoustic environment; and providing, via one of an electronic output transducer communicably coupled to the electronic digital assistant computing device and the transceiver, the auditory output for reproduction to the user in the acoustic environment.

Each of the above-mentioned embodiments will be discussed in more detail below, starting with example communication system and device architectures of the system in which the embodiments may be practiced, followed by an illustration of processing steps for achieving the improved method, device, and system for an electronic digital assistant to detect a user's acoustical environment and to substantively vary a content of its auditory output to the user as a function of the detected acoustical environment. Further advantages and features consistent with this disclosure will be set forth in the following detailed description, with reference to the figures.

1. Communication System and Device Structures

a. Communication System Structure

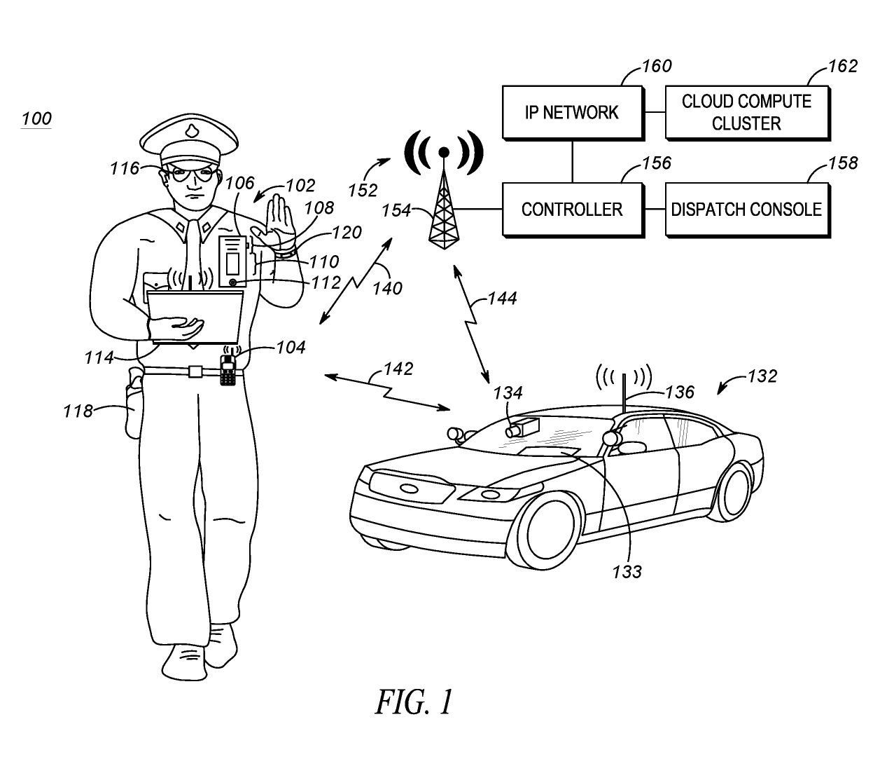

Referring now to the drawings, and in particular FIG. 1, a communication system diagram illustrates a system 100 of devices including a first set of devices that a user 102 (illustrated in FIG. 1 as a first responder police officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (e.g., which may be virtual reality, augmented reality, or mixed reality glasses), sensor-enabled holster 118, and/or biometric sensor wristband 120. Although FIG. 1 illustrates only a single user 102 with a respective first set of devices, in other embodiments, the single user 102 may include additional sets of same or similar devices, and additional users may be present with respective additional sets of same or similar devices.

System 100 may also include a vehicle 132 associated with the user 102 having an integrated vehicular computing device 133, an associated vehicular video camera 134, and a coupled vehicular transceiver 136. Although FIG. 1 illustrates only a single vehicle 132 with a respective single vehicular video camera 134 and transceiver 136, in other embodiments, the vehicle 132 may include additional same or similar video cameras and/or transceivers, and additional vehicles may be present with respective additional sets of video cameras and/or transceivers.

Each of the portable radio 104, RSM video capture device 106, laptop 114, and vehicle 132 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits.

The portable radio 104, in particular, may be any mobile computing device used for infrastructure RAN or direct-mode media (e.g., voice, audio, video, etc.) communication via a long-range wireless transmitter and/or transceiver that has a transmitter transmit range on the order of miles, e.g., 0.5-50 miles, or 3-20 miles (e.g., in comparison to a short-range transmitter such as a Bluetooth, Zigbee, or NFC transmitter) with other mobile computing devices and/or the infrastructure RAN 152. The long-range transmitter may implement a direct-mode, conventional, or trunked land mobile radio (LMR) standard or protocol such as ETSI Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 1, the portable radio 104 may form the hub of communication connectivity for the user 102, through which other accessory devices, such as a biometric sensor, an activity tracker, a weapon status sensor, a heads-up-display, the RSM video capture device 106, and/or the laptop 114 may communicatively couple.

In order to communicate with and exchange video, audio, and other media and communications with the RSM video capture device 106 and/or the laptop 114, the portable radio 104 may contain one or more physical electronic ports (such as a USB port, an Ethernet port, an audio jack, etc.) for direct electronic coupling with the RSM video capture device 106 or laptop 114, and/or may contain a short-range transmitter (e.g., in comparison to the long-range transmitter such as a LMR or Broadband transmitter) and/or transceiver for wirelessly coupling with the RSM video capture device 106 or laptop 114. The short-range transmitter may be a Bluetooth, Zigbee, or NFC transmitter having a transmit range on the order of 0.01-100 meters, or 0.1-10 meters. In other embodiments, the RSM video capture device 106 and/or the laptop 114 may contain their own long-range transceivers and may communicate with one another and/or with the infrastructure RAN 152 or vehicular transceiver 136 directly without passing through portable radio 104.

The RSM video capture device 106, in particular, provides voice functionality features similar to a traditional RSM, including one or more of acting as a remote microphone that is closer to the user's 102 mouth, providing a remote speaker allowing play back of audio closer to the user's 102 ear, and including a PTT switch or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other mobile computing devices or from the infrastructure RAN 152. The voice and/or audio played back at the remote speaker may be received from the portable radio 104 or directly from one or more other mobile computing devices or the infrastructure RAN. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture that allows a single mobile computing device to communicate with one or more group members (not shown) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other mobile computing devices or to the infrastructure RAN 152 directly. The video camera 112 and RSM remote microphone may be used, for example, for capturing audio and/or video of a suspect and the suspect's surroundings, storing the captured image and/or audio data for further analysis or transmitting the captured image and/or audio data as a video and/or audio stream to the portable radio 104 and/or to other mobile computing devices or to the infrastructure RAN directly for further analysis. The RSM remote microphone may be a directional or unidirectional microphone or array of directional or unidirectional microphones that, in the case of directional or arrays of microphones, may be capable of identifying a direction from which a captured sound emanated.

The laptop 114, in particular, may be any wireless computing device used for infrastructure RAN or direct-mode media communication via a long-range or short-range wireless transmitter with other mobile computing devices and/or the infrastructure RAN 152. The laptop 114 includes a display screen for displaying a user interface to an operating system and one or more applications running on the operating system, such as a broadband PTT communications application, a web browser application, a vehicle history database application, an arrest record database application, an outstanding warrant database application, a mapping and/or navigation application, a health information database application, or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may also be provided at the laptop 114, integrating an ability to capture video and/or audio of the user 102 and the user's 102 surroundings, or a suspect (or potential suspect) and the suspect's surroundings, and store and/or otherwise process the captured video and/or audio for further analysis or transmit the captured video and/or audio as a video and/or audio stream to the portable radio 104, other mobile computing devices, and/or the infrastructure RAN 152 for further analysis.

The smart glasses 116 may include a digital imaging device, a computing device, a short-range and/or long-range transceiver device, and/or a projecting device. The smart glasses 116 may maintain a bi-directional connection with the portable radio 104 and provide an always-on or on-demand video feed pointed in a direction of the user's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, an additional user interface mechanism such as a touch interface or gesture detection mechanism may be provided at the smart glasses 116 that allows the user 102 to interact with the display elements displayed on the smart glasses 116 or modify operation of the digital imaging device, while in other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact, may provide an augmented reality interface in which a direct or indirect view of real-world environments in which the user is currently disposed are augmented, i.e., supplemented, by additional computer-generated sensory input such as sound, video, images, graphics, GPS data, or other information, or may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the user's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. Other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information.

An accelerometer is a device that measures acceleration. Single and multi-axis models are available to detect magnitude and direction of the acceleration as a vector quantity, and can be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and can be used to determine a direction in which a person or device is facing.

The heart rate sensor may use electrical contacts with the skin to monitor an electrocardiography (EKG) signal of its wearer, or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperate sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor.

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, or other short-range wireless protocol having a transmission range on the order of meters, tens of meters, or hundreds of meters.

The portable radio 104 and/or RSM video capture device 106 (or any other electronic device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location can then be stored locally or transmitted via the transmitter or transceiver to other computing devices.

The vehicle 132 may include the vehicular computing device 133, the vehicular video camera 134, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with mobile computing devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicably coupling between the vehicular computing device 133 and/or the vehicular video camera 134 in the VAN. The vehicular computing device 133 may, in some embodiments, include the vehicular transceiver 136 and/or the vehicular video camera 134 integrated therewith, and may operate to store and/or process video and/or audio produced by the video camera 134 and/or transmit the captured video and/or audio as a video and/or audio stream to the portable radio 104, other mobile computing devices, and/or the infrastructure RAN 152 for further analysis. A microphone (not shown), or an array thereof, may be integrated in the video camera 134 and/or at the vehicular computing device 133 (or additionally or alternatively made available at a separate location of the vehicle 132) and communicably coupled to the vehicular computing device 133 and/or vehicular transceiver 136 for capturing audio and storing, processing, and/or transmitting the audio in a same or similar manner to the video as set forth above.

The vehicle 132 may be a human-operable vehicle, or may be a self-driving vehicle operable under control of vehicular computing device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link).

The vehicle 132 and/or transceiver 136, similar to the portable radio 104 and/or respective receivers, transmitters, or transceivers thereof, may include a location determination device integrated with or separately disposed in the vehicular computing device 133 and/or transceiver 136 for determining (and storing and/or transmitting) a location of the vehicle 132.

In some embodiments, instead of a vehicle 132, a land, air, or water-based drone with same or similar audio and/or video and communications capabilities and same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between, and one of the VAN and the PAN may provide infrastructure communications to the other, depending on the situation and the types of devices in the VAN and/or PAN and may provide interoperability and communication links between devices (such as video cameras) and sensors within the VAN and PAN.

Although RSM 106, laptop 114, and vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, or other types of audio and/or video recording devices accessible via a wired or wireless network interface same or similar to that disclosed herein.

Infrastructure RAN 152 is a radio access network that provides for radio communication links to be arranged within the network between a plurality of user terminals. Such user terminals may be mobile and may be known as ‘mobile stations’ or ‘mobile devices,’ and may include any one or more of the electronic computing devices illustrated in FIG. 1, among other possibilities. At least one other terminal, e.g. used in conjunction with mobile devices, may be a fixed terminal, e.g. a base station, eNodeB, repeater, and/or access point. Such a RAN typically includes a system infrastructure that generally includes a network of various fixed terminals, which are in direct radio communication with the mobile devices. Each of the fixed terminals operating in the RAN may have one or more transceivers which may, for example, serve mobile devices in a given region or area, known as a ‘cell’ or ‘site’, by radio frequency (RF) communication. The mobile devices that are in direct communication with a particular fixed terminal are said to be served by the fixed terminal. In one example, all radio communications to and from each mobile device within the RAN are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a WLAN technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-PoC, in particular and as one example of an infrastructure broadband wireless system, enables familiar PTT and “instant on” features of traditional half duplex mobile devices, but uses mobile devices operating over modern broadband telecommunications networks. Using PoC, wireless mobile devices such as mobile telephones and notebook computers can function as PTT half-duplex mobile devices for transmitting and receiving. Other types of PTT models and multimedia call models (MMCMs) are also available.

Floor control in an OMA-PoC session is generally maintained by a PTT server that controls communications between two or more wireless mobile devices. When a user of one of the mobile devices keys a PTT button, a request for permission to speak in the OMA-PoC session is transmitted from the user's mobile device to the PTT server using, for example, a real-time transport protocol (RTP) message. If no other users are currently speaking in the PoC session, an acceptance message is transmitted back to the user's mobile device and the user can then speak into a microphone of the device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other mobile devices in the group of mobile devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of mobile devices is partitioned into separate groups of mobile devices. In a conventional system, each mobile device in a group is selected to a particular radio channel (frequency or frequency & time slot) for communications associated with that mobile device's group. Thus, each group is served by one channel, and multiple groups may share the same single frequency (in which case, in some embodiments, group IDs may be present in the group data to distinguish between groups using the same shared frequency).

In contrast, a trunked radio system and its mobile devices use a pool of traffic channels for virtually an unlimited number of groups of mobile devices (e.g., talkgroups). Thus, all groups are served by all channels. The trunked radio system works to take advantage of the probability that not all groups need a traffic channel for communication at the same time. When a member of a group requests a call on a control or rest channel on which all of the mobile devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the mobile devices were idling to a traffic channel for the call, and instruct all mobile devices that are not participating in the new call to move to a newly assigned control or rest channel selected from the pool of available channels. With a given number of channels, a much greater number of groups can be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., mobile devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, mobile devices may dynamically affiliate with a group (and also disassociate with the group) perhaps based on user input, and the switching and/or radio network may track group membership and route new group calls according to the current group membership.

In some instances, broadband and narrowband systems may be interfaced via a middle-ware system that translates between a narrowband PTT standard protocol (such as P25) and a broadband PTT standard protocol (such as OMA-PoC). Such intermediate middle-ware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middle-ware server may be disposed in infrastructure RAN 152 at controller 156 or at a separate cloud computing cluster 162 communicably coupled to controller 156 via internet protocol (IP) network 160, among other possibilities.

The infrastructure RAN 152 is illustrated in FIG. 1 as providing coverage for the portable radio 104, RSM video capture device 106, laptop 114, and vehicle transceiver 136 via a single fixed terminal 154 coupled to a single controller 156 (e.g., radio controller, call controller, PTT server, zone controller, MME, BSC, MSC, site controller, Push-to-Talk controller, or other network device) and including a dispatch console 158 operated by a dispatcher. In other embodiments, additional fixed terminals and additional controllers may be disposed to support a larger geographic footprint and/or a larger number of mobile devices.

The controller 156 illustrated in FIG. 1, or some other backend electronic computing device existing on-premises or in the remote cloud compute cluster 162 accessible via the IP network 160 (such as the Internet), may additional or alternatively operate as a back-end electronic digital assistant, a back-end audio and/or video processing electronic computing device, and/or a remote cloud-based storage device consistent with the remainder of this disclosure.

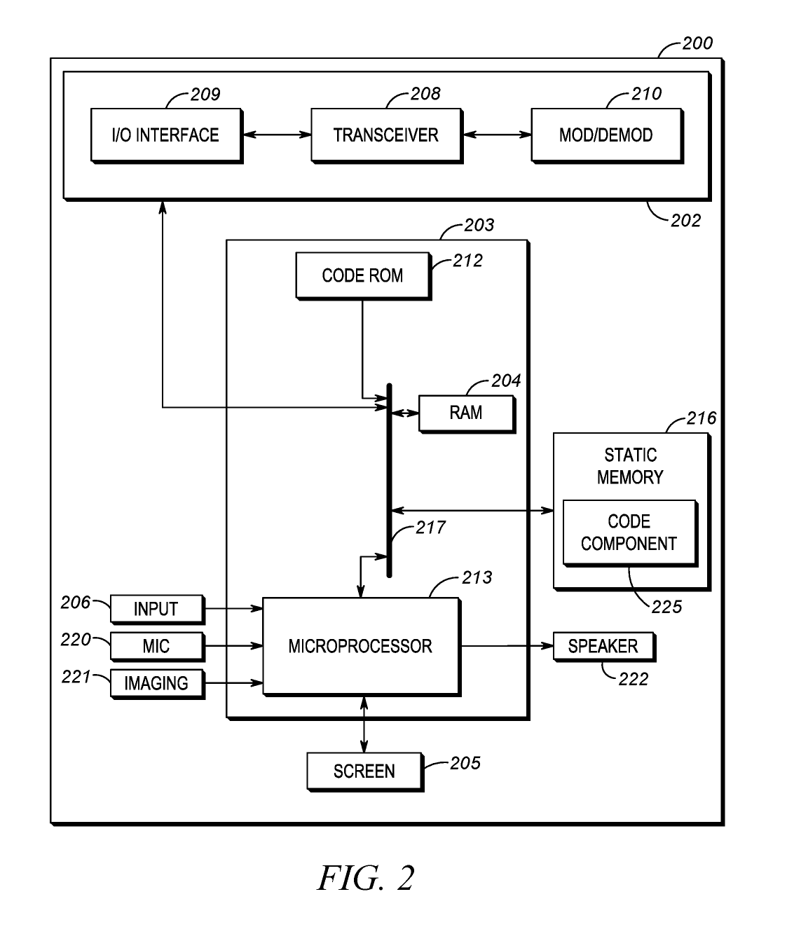

The IP network 160 may comprise one or more routers, switches, LANs, WLANs, WANs, access points, or other network infrastructure, including but not limited to, the public Internet. The cloud compute cluster 162 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud compute cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic digital assistant service.

Finally, although FIG. 1 describes a communication system 100 generally as a public safety communication system includes a user 102 generally described as a police officer and vehicle 132 generally described as a police cruiser, in other embodiments, the communications system 100 may additionally or alternatively be a retail communications system including a user 102 that may be an employee of a retailer and a vehicle 132 that may be a vehicle for use by the user 102 in furtherance of the employee's retail duties (e.g., a shuttle or self-balancing scooter). In other embodiments, the communications system 100 may additionally or alternatively be a warehouse communications system including a user 102 that may be an employee of a warehouse and a vehicle 132 that may be a vehicle for use by the user 102 in furtherance of the employee's retail duties (e.g., a forklift). In still further embodiments, the communications system 100 may additionally or alternatively be a private security communications system including a user 102 that may be an employee of a private security company and a vehicle 132 that may be a vehicle for use by the user 102 in furtherance of the private security employee's duties (e.g., a private security vehicle or motorcycle). In even further embodiments, the communications system 100 may additionally or alternatively be a medical communications system including a user 102 that may be a doctor or nurse of a hospital and a vehicle 132 that may be a vehicle for use by the user 102 in furtherance of the doctor or nurse's duties (e.g., a medical gurney or ambulance). In a last example embodiment, the communications system 100 may additionally or alternatively be a heavy machinery communications system including a user 102 that may be a miner, driller, or extractor at a mine, oil field, or precious metal or gem field and a vehicle 132 that may be a vehicle for use by the user 102 in furtherance of the miner, driller, or extractor's duties (e.g., an excavator, bulldozer, crane, front loader). Other possibilities exist as well.

b. Device Structure

Referring to FIG. 2, a schematic diagram illustrates an electronic computing device 200 for operating an electronic digital assistant according to some embodiments of the present disclosure. Electronic computing device 200 may be, for example, embodied in the portable radio 104, RSM video capture device 106, laptop 114, vehicular electronic processor 133, controller 156, or some other electronic computing device not illustrated in FIG. 1 including the remote cloud compute cluster described above, and/or may be a distributed computing device across two or more of the foregoing (or multiple of a same type of one of the foregoing) and linked via a wired and/or wireless communication link(s). As shown in FIG. 2, computing device 200 includes a communications unit 202 coupled to a common data and address bus 217 of a processing unit 203. The computing device 200 may also include an input unit (e.g., keypad, pointing device, touch-sensitive surface, etc.) 206 and an electronic display screen 205, each coupled to be in communication with the processing unit 203.

A microphone 220 may be present for capturing audio from a user and/or other environmental or background audio that is further processed by processing unit 203 in accordance with the remainder of this disclosure and/or is transmitted as voice or audio stream data, or as acoustical environment indications, by communication unit 202 to other portable radios and/or other electronic computing devices. An imaging device 221 may provide video (still or moving images) of an area in a field of view of the computing device 200 for further processing by the processing unit 203 and/or for further transmission by communications unit 202. A communications speaker 222 may be present for reproducing audio that is decoded from voice or audio streams of calls received via the communication unit 202 from other portable radios, from digital audio stored at the computing device 200, from other ad-hoc or direct mode devices, and/or from an infrastructure RAN device, or may play back alert tones or other types of pre-recorded audio.

The processing unit 203 may include a code Read Only Memory (ROM) 212 coupled to the common data and address bus 217 for storing data for initializing system components. The processing unit 203 may further include a microprocessor 213 coupled, by the common data and address bus 217, to a Random Access Memory (RAM) 204 and a static memory 216.

The communications unit 202 may include one or more wired and/or wireless input/output (I/O) interfaces 209 that are configurable to communicate with other devices, such as a portable radio, laptop, wireless RAN, and/or vehicular transceiver.

For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or other similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

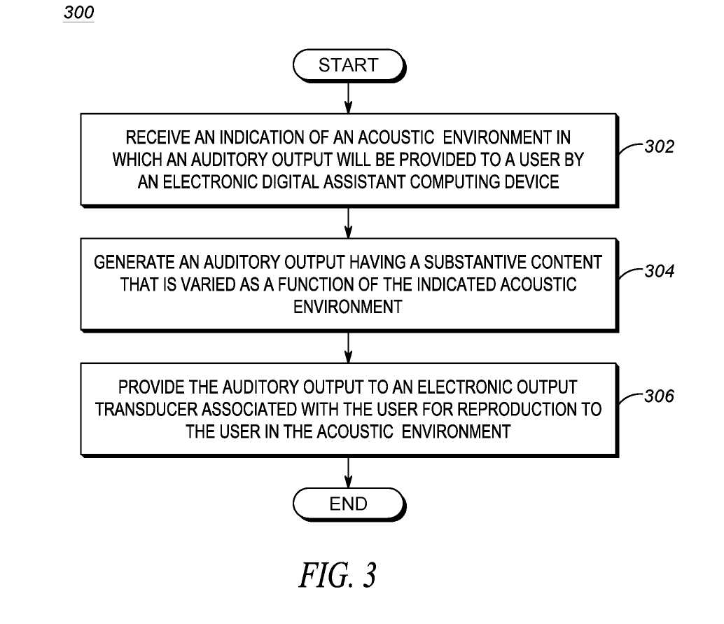

The microprocessor 213 has ports for coupling to the input unit 206 and the microphone unit 220, and to the display screen 205, imaging device 221, and speaker 222. Static memory 216 may store operating code 225 for the microprocessor 213 that, when executed, performs one or more of the computing device steps set forth in FIG. 3 and accompanying text. Static memory 216 may also store, permanently or temporarily, a threshold level mapping indicating numerical ranges at which auditory output generated by the electronic digital assistant may be lengthened and/or shortened, a database of acronyms and their associated full terms for use in transitioning between one or the other based on a detected acoustic environment, a thesaurus database of terms having similar meanings and optionally including a syllable count and/or hardness rating for use in transitioning between them based on a detected acoustic environment, a 10-code database including the 10-code and the 10-codes associated full term meaning for use in transitioning between one or the other based on a detected acoustic environment, a pronoun database that maps proper names of people, places, or things to associated pronouns, a contraction database setting forth contractions and the terms they stand for use in transitioning between one or the other based on a detected acoustic environment, and an abbreviation database including the abbreviation and the full term that the abbreviation abbreviates for use in transitioning between one or the other based on a detected acoustic environment.

Static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, to name a few.

2. Processes for Detecting a User's Acoustical Environment and Substantively Varying a Content of its Auditory Output to the User as a Function of the Detected Acoustical Environment

Turning now to FIG. 3, a flowchart diagram illustrates a process 300 for an electronic computing device operating as an electronic digital assistant to detect a user's acoustical environment and substantively vary a content of its auditory output to the user as a function of the detected acoustical environment. While a particular order of processing steps, message receptions, and/or message transmissions is indicated in FIG. 3 for exemplary purposes, timing and ordering of such steps, receptions, and transmissions may vary where appropriate without negating the purpose and advantages of the examples set forth in detail throughout the remainder of this disclosure. The computing device may execute process 300 at power-on, at some predetermined periodic time period thereafter, in response to a trigger raised locally at the device via an internal process or via an input interface (e.g., the user enabling a particular feature associated with process 300 or the computing device detecting that the computing device has entered a particular area or vehicle or that a user thereof has exited a particular area or vehicle, among other possibilities), or in response to detecting a trigger (including receipt of media content for processing in accordance with process 300) from a portable radio, vehicle, or infrastructure controller to which it is communicably coupled, among other possibilities.

The computing device executing process 300 may include an edge device same or similar to any one or more of the portable radio 104, the RSM 106, the laptop 114, or the vehicle computing device 133 illustrated in FIG. 1, may include an infrastructure device same or similar to the controller 156 of FIG. 1, may include some other in-field, infrastructure RAN, or remote cloud computing cluster 162 device, or may include two or more of the foregoing operating in a distributed computing manner, among other possibilities.

Process 300 begins at step 302 where an electronic computing device operating as an electronic digital assistant receives an indication of an acoustic environment in which an auditory output will be provided to a user. The indication of the acoustic environment may be, for example, a measured background noise level measured via one or more input audio transducers at or near the user, such as the microphone at the RSM video capture device 106, laptop 114, or vehicle 132 described above with respect to FIG. 1, and having a sound pressure value measured in decibels. Additionally or alternatively, other units of sound pressure values could be used, including but not limited to, bels, nepers, power ratios, and field ratios. Further normalizations could be additionally applied to the measured sound pressure value to produce other relative measures of loudness, such as Sone (in units N) or Phon (in units L). Other parameters relating to the background noise may be received or measured as part of the indication as well as well, including but not limited to pitch and periodicity. Other possibilities exist as well.

In the event that the electronic computing device executing one or more of steps 302-306, but at least step 302, includes the microphone or microphone array measuring the sound pressure value incorporated within, or directly electrically coupled thereto, the same electronic computing device may execute the electronic digital assistant steps 304-306 and also generate the indication of the acoustic environment which is then received via internal circuits and/or data buses at the processing component performing step 302 (e.g., the RSM video capture device 106 may generate the indication and also receive it at step 302). In other embodiments in which the electronic computing device executing the electronic digital assistant steps 302-306 is not the same electronic computing device generating the indication of the acoustic environment, the electronic computing device may receive the indication via a wired or wireless network (e.g., the RSM video capture device 106 may generate the indication via a measurement of the background noise/environment near user 102 and wirelessly transmit the indication to another electronic computing device executing one or more of steps 302-306, such as perhaps the controller 156 of FIG. 1).

The indication of the acoustic environment may be measured by and therefore reflect a randomly captured instantaneous measurement of a noise level near the user to which the auditory output of the electronic digital assistant will be provided, may reflect an intentionally non-randomly captured instantaneous measurement of a noise level near the user to which the auditory output of the electronic digital assistant will be provided (e.g., taken when the PTT button is not activated or when the user is determined not to be talking), or may reflect an average of measured noise levels over a contiguous or plurality of non-contiguous periods of time (e.g., randomly and/or non-randomly in accordance with the foregoing description). The indication may be generated and transmitted periodically to the electronic computing device, semi-periodically, or upon request from the electronic computing device.

The auditory output to be provided to the user by the electronic digital assistant may be generated as a result of a prior query from the same user to which the auditory output is to be provided (e.g., the auditory output is a reactive response to a prior query), may be generated as a result of a proactive context-trigger that may alert the user to some situation or piece of information that the electronic digital assistant has determined may be relevant to the user (e.g., the auditory output is a proactive response to some other information-based trigger), or may be generated as a result of some other user or dispatcher query wherein the electronic digital assistant determines that the auditory output may be of relevance or interest to the user (e.g., some other user may have submitted a query and be in a same talkgroup as the user, or may have explicitly requested that the response be provided individually to the user, among other possibilities).

In some embodiments, the electronic computing device may receive a plurality of indications from a plurality of different acoustic environments associated with a plurality of different users (and their respective devices) that may have some relationship with one another, such as all being in a same talkgroup, all being indicated targets to which the auditory output will be provided (as decided by the electronic digital assistant or as requested by some other user query), or all being in a same organizational department or division, among other possibilities. For example, each of the plurality of different users may have some associated mobile or vehicular computing device that includes a microphone that may take noise level measurements (and/or other measurements as noted above) as noted above, and which may separately provide such measurements, perhaps accompanying location information, to the electronic computing device, which may then store such acoustic environment indications. In the event that there is some relationship among the plurality of different users and/or devices, the electronic computing device at step 302 may keep track of a worst-case acoustic environment indication among the plurality received, and/or may keep track of a running average or weighted average acoustic environment indication among the plurality received, among other possibilities.

At step 304, the electronic computing device generates an auditory output having a substantive content that is varied as a function of the indicated acoustic environment received at step 302. The substantive content refers to the choice of terms (e.g., single words or multiple word phrases) in the response to be provided via an auditory output to the user. More specifically, the substantive content is varied to reduce a time to playback, and/or to use more meaningful (e.g., familiar, prioritized, preferred, or relevant, as pre-ranked in some manner manually or ranked computationally via some neural network/feedback algorithm and perhaps varying based on a context of the user, such as the user's job, role, type of project assigned, type of incident assigned, type of agency working for, etc.) terms, independent of and indifferent to (or at a lower relative weighting to) any hardness values assigned to the terms, for the auditory output, so as to convey information to the user more quickly and clearly as long as the acoustic environment in which the auditory output will be provided to the user is determined to support it. The electronic computing device may determine whether the acoustic environment in which the auditory output will be provided to the user supports such reduced playback time (or more meaningful term selection) by comparing the received acoustic environment indication (or indications) to one or more sound pressure level threshold values. For example, a first threshold level of sound pressure level of 70-90 dB may be applied, or 75-85 dB, or 80 dB, such that if the indication of the acoustic environment falls below the first threshold level, the auditory output generated at step 304 may be generated to have a substantive content intended to reduce a time to playback (and/or more meaningful term selection for) the auditory output. An acoustic environment indication below this first threshold is said to have a low-noise acoustic environment.

The substantive content of the auditory output may be modified to reduce the time to playback the auditory output in a number of ways. For example, by using or preferring contractions instead of multiple term phrases (e.g., “isn't” instead of “is not”), by using or preferring synonymous terms having fewer syllables instead of terms having more syllables (e.g., “car” instead of “vehicle”), by using or preferring using 10-code(s) instead of descriptions of the 10-code(s) (e.g., “10-4” instead of “acknowledged”), by using or preferring acronyms instead of the multiple terms with which they abbreviate (e.g., “BOLO” instead of “be on the look out”), by using pronouns to refer to people, places, or things instead of pronounse (e.g., “him” instead of “Dr. John Jenkowitzschneigel”), by using or preferring abbreviations instead of the single full term with which they abbreviate (e.g., “perp” instead of “perpetrator”). Other examples exist as well. In some instances, the electronic computing device may use all of the above to reduce the time to playback the auditory output, while in other embodiments, the electronic computing device may use only one or more of the foregoing to reduce the time to playback the auditory output. In some embodiments, as the acoustic environment indication increases in steps towards the first threshold, additional ones of the foregoing may be applied in a continuous or semi-continuous manner (e.g., one at 60 dB, two at 65 dB, three at 70 dB, four at 75 dB, and five at 80 dB, or other steps of dB towards a threshold example of 80 dB, such as 2, 3, 4, or 6 dB).

The electronic computing device may implement the foregoing by accessing local or remote respective databases in generating the auditory output having the substantive content varied as a function of the indicated acoustic environment. For example, a database mapping contractions to corresponding term phrases may be accessed by the electronic computing device in generating the auditory output, a same or different database mapping synonymous terms and including syllable counts as linked metadata may be accessed by the electronic computing device in generating the auditory output, a same or different database mapping 10-codes to descriptions thereof may be accessed by the electronic computing device in generating the auditory output, a same or different database mapping proper nouns of people, places, or things to associated pronouns, a same or different database mapping acronyms to the multiple terms that they abbreviate may be accessed by the electronic computing device in generating the auditory output, and a same or different database mapping abbreviations to the single terms that they abbreviate may be accessed by the electronic computing device in generating the auditory output.

In performing the foregoing selecting of substantive content in a low-noise acoustic environment, the substantive content of the auditory output may be modified to choose terms more closely matching an intended meaning or matching a target industry or function associated with the user (i.e., more meaningful terms as defined earlier) independent of (or at a lower weighting to) the hardness ratings assigned to the terms. A hardness rating of a term is directly correlated to a measured change in air pressure when reproducing the term relative to other synonymous terms. The highest hardness ratings are assigned to stop, or plosive or oral occlusive terms (e.g., an obstruent), in which the vocal tract is blocked so that all airflow ceases (causing a high rate of change in air pressure) and creates a hard, easier to understand reproduction, especially valuable in high-noise environments. For example, terms with consonants “t”, “d”, “k”, “g”, “p”, “b”, “q”, and “c” are prevalent in stop terms. In some embodiments, the classification of the consonant may depend on what letters follow the consonant. i.e., a “c” followed by an “a”, “o”, or “u” general implies a hard “c” that would classify as a high hardness stop consonant, but a “c” followed by an “e”, “i”, or “y” generally implies a soft “c” that would not classify as a high hardness stop consonant. Such phonetic differentiations may be identified in a stored database and factored into the term classification as well.

Stop terms are considered in stark contrast to, for example, nasal terms (e.g., a sonorant), in which speech is produced with continuous, non-turbulent airflow in the vocal tract, and are generally heard as softer consonants. Example nasal consonants include “n” and “m”. Accordingly, terms having a higher hardness rating (e.g., obstruents more highly ranked than sonorants, and within obstruents, stops more highly ranked than over affricate and fricative) are easier to hear and discern in a high-noise environment, and may thus be assigned higher hardness ratings. Hardness rating values assigned may be, for example, based on a number (or percentage or ratio) of obstruent consonants in the term (perhaps further taking into consideration phonetic pronunciations as set forth above), the number (or percentage or ratio) of stop consonants in the term (again perhaps further taking into consideration phonetic pronunciations as set forth above), or may be assigned a weighting in which each stop consonant counts as a highest value (again perhaps further taking into consideration phonetic pronunciations as set forth above) of, say, 5 points, each affricate consonant counts as 4, and each fricative consonant counts as 3 (among other relative various weightings that could be applied).

Accordingly, as long as the acoustic environment is low-noise, i.e., below the first threshold, the electronic computing device may generate the auditory output by selecting shorter terms or more meaningful terms independent of (or weighted more heavily than) hardness ratings assigned to the terms.

Similar to the foregoing but opposite in application, the substantive content of the generated auditory output at step 304 may also be varied to lengthen a time to playback and/or use terms with higher hardness ratings (perhaps independent of or more highly rated than a meaningfulness of the terms) for the auditory output to get the information to the user in a high-noise acoustic environment. The electronic computing device may determine whether the acoustic environment in which the auditory output will be provided to the user requires such lengthened playback time (or requires a selection of terms having higher hardness values) by comparing the received acoustic environment indication (or indications) to one or more second sound pressure level threshold values. For example, a second threshold level of sound pressure level of 85-105 dB may be applied, or 90-100 dB, or 95 dB, such that if the indication of the acoustic environment raises above the second threshold level, the auditory output generated at step 304 may be generated to have a substantive content intended to lengthen a time to playback (and/or select higher hardness terms) of the auditory output. An acoustic environment indication above this second threshold is said to have a high-noise acoustic environment.

The substantive content of the auditory output may be modified to lengthen the time to playback the auditory output in a number of ways directly opposite to those noted above with respect to auditory environments falling below the first threshold level (e.g., by using or preferring multiple term phrases instead of contractions (e.g., “is not” instead of isn't), and the same inversion applied with respect to synonyms, 10-codes, acronyms, and abbreviations).

In some instances, the electronic computing device may use all of the above substitutions to lengthen the time to playback the auditory output, while in other embodiments, the electronic computing device may use only one or more of the foregoing to lengthen the time to playback the auditory output. In some embodiments, as the acoustic environment indication increases in steps above the second threshold, additional ones of the foregoing may be applied in a continuous or semi-continuous manner. (e.g., one at 95 dB, two at 100 dB, three at 105 dB, four at 110 dB, and five at 115 dB, or other steps of dB beyond the threshold example of 95 dB, such as 2, 3, 4, or 6 dB).

The electronic computing device may implement the foregoing by similarly accessing local or remote respective databases in generating the auditory output having the substantive content varied as a function of the indicated acoustic environment.

In performing the foregoing selection of substantive content in a high-noise acoustic environment, the substantive content of the auditory output may be modified to choose terms having a higher hardness rating (perhaps independent of how meaningful a term is or applying lower weighting to meaningfulness relative to hardness). Accordingly, and when accessing the database of synonyms, the electronic computing device may prefer synonymous terms having a higher hardness rating than terms having a lower hardness rating when the acoustic environment indicates a high noise environment at or above the second threshold. Additionally or alternatively, on overall weight may be calculated and assigned to each synonymous term based on a sum or average or other mathematical operation taking into account both hardness weighting and number of syllables, among other possibilities.

Accordingly, while meaningfulness rankings may be assigned as well, the electronic computing device may transition from a state below the first threshold acoustic environment in which assigned hardness weightings may be ignored to a state above the second threshold acoustic environment in which hardness is at least considered (e.g., weighted relative to more syllables and/or higher meaningfulness) and perhaps even being a sole determinative parameter of synonym selection.

In still further embodiments, the substantive content of the auditory output may be further re-arranged to place a more or most important information at a beginning of the audio output where the user's attention in a high-noise environment is most likely to be at its height relative to the played back audio, and furthermore, may include adding a machine-generated loud tone or siren at the beginning of the substantive content to further focus the user's attention on the audio in the high noise environment.

Generating the auditory output at step 304 may include generating a text-based output for reproduction at a mobile or vehicular computing device associated with the user (e.g., including an output transducer speaker associated with the user) via a text-to-voice software component at the mobile or vehicular computing device that converts text to voice for output to a user via a local output transducer speaker. For example, an electronic digital assistant operating at controller 156 or RSM 106 may generate an auditory output text file and transmit it to laptop 114 for reproduction. As another example, an electronic digital assistant operating at laptop 114 may generate an auditory output text file for local reproduction at the laptop 114.

Alternatively, generating the auditory output at step 304 may include generating a digital audio file with digitally-encoded speech that recites the substantive content generated at step 304 for reproduction to a user. For example, an electronic digital assistant operating at controller 156 or RSM 106 may generate an auditory output digitally-encoded speech file and transmit it to laptop 114 for reproduction. As another example, an electronic digital assistant operating at laptop 114 may generate an auditory output digitally-encoded speech file for local reproduction at the laptop 114.

At step 306, the electronic computing device provides the auditory output generated at step 304 (e.g., the text file and/or the digitally-encoded speech file) to an electronic output transducer associated with the user for production to the user in the acoustic environment. Providing the auditory output may include transmitting, via one or more wired or wireless networks or links, the auditory output file (e.g., text file or digitally-encoded speech file) to a mobile or vehicular computing device or other computing device associated with the user for receipt and subsequent reproduction at the mobile or vehicular computing device, e.g., via a text-to-voice software component that converts the text to voice file to audio for reproduction via an output transducer associated with the user, or via a digital audio playback software that converts the digitally-encoded speech file to an audio signal for reproduction via an output transducer associated with the user. In the event that the electronic digital assistant is running on a same device that is to reproduce the auditory output to the user, providing the auditory output may include merely internally routing audio signals, generated via a local text-to-voice software component or via a digital audio playback software, to an output transducer of the device for playback to the user.

In some embodiments, providing the auditory output generated at step 304 may causing a broadband (e.g., LTE) or narrowband (e.g., LMR) call controller (such as controller 156 of FIG. 1) communicatively coupled to the electronic computing device to establish an LTE or LMR private/unicast call to the user or an LTE or LMR group call that includes the user, and causing the auditory output to be reproduced to the user via the established LTE or LMR call.

As a further example, where the electronic digital assistant receives a plurality of acoustic environment indications from a plurality of mobile devices associated with a group of users, providing the auditory output at step 306 may include providing the auditory output on an LTE or LMR group voice call to the plurality of users, providing the auditory output on a plurality of LTE or LMR unicast/private call sessions to the plurality of users, or some combination thereof, for reproduction of the acoustic output at each one of the plurality of mobile devices. In the case of using a group voice call or voice channel, the auditory output may be generated having a substantive content that is a varied as a function of a worst case acoustic environment or of an average acoustic environment across the plurality of acoustic environment indications from the plurality of mobile devices, as discussed earlier. In the case of using a plurality of private or unicast calls, the auditory content provided to each mobile device in the group may be varied differently based on the individual acoustic environment indication received from that particular mobile device in the group of users/mobile devices.

3. Conclusion

In accordance with the foregoing, a method, device, and system for an electronic digital assistant to detect a user's acoustical environment and to substantively vary a content of its auditory output to the user as a function of the detected acoustical environment. As a result of the foregoing, electronic digital assistant voice responses may be provided to users across a variety of differing acoustic environments, and digital assistant produced audio can be substantively varied so that it could still be understood in high-noise environments, while the digital assistant produced audio can be varied to more quickly or meaningfully provide the information needed to the user in a low-noise environment. Other benefits and advantages are possible as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method at an electronic digital assistant computing device for detecting a user's acoustical environment and substantively varying a content of a generated auditory output to the user as a function of the detected acoustical environment, the method comprising:
receiving, at an electronic digital assistant computing device, an indication of an acoustic environment in which an auditory output will be provided by the electronic digital assistant computing device to a user;
generating, at the electronic digital assistant computing device, an auditory output having a substantive content that is varied as a function of the indication of the acoustic environment; and
providing, by the electronic digital assistant computing device, the auditory output to an electronic output transducer associated with the user for reproduction to the user in the acoustic environment.

2. The method of claim 1, wherein the indication of the acoustic environment includes one or more of a noise level, a pitch, and a periodicity of noise measured at a noise level sensor associated with the user.

3. The method of claim 2, wherein the indication of the acoustic environment is a numerical value measured in decibels.

4. The method of claim 2, wherein when the noise level is below a first threshold level, the substantive content of the auditory output is shortened to decrease a time to playback the auditory output to the user.

5. The method of claim 4, wherein the substantive content is shortened by one of: using acronyms where possible instead of using underlying terms that the acronym represents, accessing a thesaurus and choosing terms having fewer syllables than other terms having more syllables and substantially a same meaning as one another, using 10-codes instead of underlying text descriptions of such 10-codes, using pronouns to refer to people, places, or things instead of proper names, using contractions instead of underlying terms with which the contractions are short for, and using abbreviations for terms instead of underlying terms with which the abbreviations are short for.

6. The method of claim 4, wherein the substantive content is shortened by all of: using acronyms where possible instead of using underlying terms that the acronym represents, accessing a thesaurus database and choosing terms having fewer syllables than other terms having more syllables and substantially a same meaning as one another, using 10-codes instead of underlying text descriptions of such 10-codes, using pronouns to refer to people, places, or things instead of proper names, using contractions instead of underlying terms with which the contractions are short for, and using abbreviations for terms instead of underlying terms with which the abbreviations are short for.

7. The method of claim 4, wherein the first threshold level is between 75 and 85 dB.

8. The method of claim 2, wherein when the noise level is below a first threshold level, the substantive content of the auditory output modified by:
accessing a thesaurus database wherein synonyms having substantially a same meaning as one another are also assigned hardness ratings based on a measured change in air pressure when reproducing the synonym relative to other synonymous terms; and
choosing shorter terms having fewer syllables or terms more closely matching an intended meaning, independent of, or having a higher priority than, the hardness ratings assigned to the terms.

9. The method of claim 2, wherein when the noise level is above a second threshold level, the substantive content of the auditory output is lengthened to increase a time to playback the auditory output to the user.

10. The method of claim 9, wherein the substantive content is lengthened by one of: not using acronyms where possible and instead using underlying terms that the acronym represents, accessing a thesaurus database and choosing terms having more syllables than other terms having fewer syllables and substantially a same meaning as one another, not using 10-codes and instead using text descriptions of such 10-codes, using proper names instead of pronouns to refer to people, places, or things, not using contractions and instead using underlying terms with which the contractions are short for, and not using abbreviations for terms and instead using underlying terms with which the abbreviations are short for.

11. The method of claim 9, wherein the substantive content is shortened by all of: not using acronyms where possible and instead using underlying terms that the acronym represents, accessing a thesaurus and choosing terms having more syllables than other terms having fewer syllables and substantially a same meaning as one another, not using 10-codes and instead using text descriptions of such 10-codes, using proper names instead of pronouns to refer to people, places, or things, not using contractions and instead using underlying terms with which the contractions are short for, and not using abbreviations for terms and instead using underlying terms with which the abbreviations are short for.

12. The method of claim 9, wherein the second threshold level is between 95 and 105 dB.

13. The method of claim 2, wherein when the noise level is above a second threshold level, the substantive content of the auditory output modified by:
accessing a thesaurus database wherein synonyms having substantially a same meaning as one another are also assigned hardness ratings based on a measured change in air pressure when reproducing the synonym relative to other synonymous terms; and
choosing a synonymous term having a higher hardness rating assigned to the term relative to other synonymous terms independent of, or having a higher priority than, length or how closely the term matches an intended meaning.

14. The method of claim 1, wherein the electronic digital assistant computing device is a mobile computing device associated with the user and the mobile computing device further including the electronic output transducer.

15. The method of claim 1, wherein the electronic digital assistant computing device is a computing device remote from the user and that communicates with a mobile computing device associated with the user and including the electronic output transducer via a wireless radio access network.

16. The method of claim 1, wherein the electronic digital assistant computing device is a distributed computing device that includes computing components disposed at a mobile computing device associated with the user, the mobile computing device further including the electronic output transducer, and computing components disposed at a remote computing device that communicates with the mobile computing device via a wireless radio access network.

17. The method of claim 1, the method further comprising:
receiving, at the electronic digital assistant computing device, indications of a plurality of respective acoustic environments in which a plurality of users to which an auditory output will be provided by the electronic digital assistant computing device, the plurality of users forming a talkgroup of users;
generating, at the electronic digital assistant computing device, an auditory output having a substantive content that is generated as a function of the indications of the acoustic environments; and
providing, by the electronic digital assistant computing device, the auditory output to electronic output transducers associated with each user for reproduction to the user in the respective acoustic environments via a talkgroup session.

18. The method of claim 17, wherein the substantive content of the auditory output is generated based on an average of the indications of the plurality of respective acoustic environments across the talkgroup of users.

19. The method of claim 17, wherein the substantive content of the auditory output is generated based on a worst-case acoustic environment indication out of the plurality of respective acoustic environments across the talkgroup of users.

20. A computing device implementing an electronic digital assistant for detecting a user's acoustical environment and substantively varying a content of an auditory output to the user as a function of the detected acoustical environment, the electronic computing device comprising:
a memory storing non-transitory computer-readable instructions;
a transceiver; and
one or more processors configured to, in response to executing the non-transitory computer-readable instructions, perform a first set of functions comprising:
receive, via one of the transceiver and a sensor communicably coupled to the electronic digital assistant computing device, an indication of an acoustic environment in which an auditory output will be provided by the electronic digital assistant computing device to a user;
generating an auditory output having a substantive content that is varied as a function of the indication of the acoustic environment; and
providing, via one of an electronic output transducer communicably coupled to the electronic digital assistant computing device and the transceiver, the auditory output for reproduction to the user in the acoustic environment.
